(19) United States
(12) Patent Application Publication
(10) Pub. No.: US 2011/0315717 A1
(43) Pub. Date: Dec. 29, 2011

(54) SELF-ADJUSTING HANDLE FOR SPRAY BOTTLES

(76) Inventors: Valerie R. Lewandowski, Naples, FL (US); Tyler W. Fyke, Naples, FL (US)

(21) Appl. No.: 12/895,982

(22) Filed: Oct. 1, 2010

Related U.S. Application Data
(60) Provisional application No. 61/357,988, filed on Jun. 24, 2010.

(51) Int. Cl. B67D 7/58; B67D 3/00

(52) U.S. Cl. 222/383.1; 222/526

(57) ABSTRACT

A self-adjusting handle (2) for a spray bottle (1) having a head (5) extending from a handle (2) that is attached to a cap (6) via a pivot joint (4), a ball joint (15) or a universal joint (20). The cap is attached to a reservoir (7) having a threaded portion that screws into a threaded portion (13) of the cap. A trigger lever (8) located on the head activates a pump (9). The pump is attached to a supply tube (10) that draws fluid from the reservoir. The pump 9 forces liquid up through the supply tube, through a barrel (11) and out a nozzle (12). The pivot joint, a ball joint and universal joint allow a user to pivot the head forward or backward while the reservoir remains in an upright position, thereby ensuring that the bottom of the supply tube maintains constant contact with the liquid in the reservoir.

### CROSS REFERENCE TO RELATED APPLICATION

This application claims the benefit of U.S. Provisional Patent Application No. 61/357,988, filed Jun. 24, 2010. The patent application identified above is incorporated here by reference in its entirety to provide continuity of disclosure.

### BACKGROUND OF THE INVENTION

This invention relates to the spray bottles, more particularly, a self-adjusting spray nozzle handle for spray bottles that allows a user to use the spray bottle at any angle while maintaining constant contact between the supply tube and the liquid contained within the spray bottle.

Conventional spray bottles are commonly used for a variety of applications. Conventional spray bottles often comprise a head that screws onto a bottle or reservoir. The spray-bottle head comprises a trigger lever that activates a small pump. The pump is attached to a supply tube that draws fluid from the bottom of the reservoir. The pump forces this liquid up through the supply tube, through a narrow barrel and out a nozzle. A problem arises with conventional spray bottles when the spray bottle is used at different angles. For example, if a user is spraying a horizontal surface, such as a floor, then the spray bottle must be placed in an angled or horizontal position. This causes the liquid within the reservoir to shift away from the end of the supply tube, thereby causing the tube to suck in only air.

Therefore, a need exists for a spray bottle having a head that allows the spray bottle to be used at any angle.

The relevant prior art includes the following patent references:

| Patent/Serial No. | | |
|---|---|---|
| (U.S. unless stated otherwise) | Inventor | Issue/Publication Date |
| CN101474606 | Li et al. | Jul. 08, 2009 |
| 2008/0245824 | Lyles | Oct. 09, 2008 |
| 7,316,362 | Miyauchi | Jan. 08, 2008 |
| 2006/0237485 | An | Oct. 26, 2006 |
| 6,732,958 | Norville et al. | May 11, 2004 |
| 6,592,057 | Ericksen et al. | Jul. 15, 2003 |
| 6,508,415 | Wang | Jan. 21, 2003 |
| 6,409,103 | Norville et al. | Jun. 25, 2002 |
| GB2353828 | Ridehalgh et al. | Mar. 07, 2001 |
| 6,027,041 | Evans | Feb. 22, 2000 |
| JP9192554 | Michio | Jul. 29, 1997 |
| 5,195,664 | Rhea | Mar. 23, 1993 |
| 5,149,146 | Simoni | Sep. 22, 1992 |
| 5,072,884 | Ellison et al. | Dec. 17, 1991 |
| 4,035,004 | Hengesbach | Jul. 12, 1977 |
| 2,647,796 | Ziherl | Aug. 04, 1953 |
| 2,456,182 | Goble | Dec. 14, 1948 |

### SUMMARY OF THE INVENTION

The primary object of the present invention is to provide a self-adjusting handle for spray bottles that allows the spray bottle to be used at any angle of spraying.

Another object of the present invention is to provide a self-adjusting handle for spray bottles that allows a user to spray liquid from the spray bottle when it is less than full or near empty.

The present invention fulfills the above and other objects by providing a spray bottle comprising a head having a threaded portion that screws onto a reservoir having a corresponding threaded portion. The spray bottle head comprises a trigger lever that activates a small pump. The pump is attached to a supply tube that draws fluid from the bottom of the reservoir. The pump forces this liquid up through the supply tube, through a narrow barrel and out a nozzle. A special coupling means, such as a pivot joint, a ball joint, a universal joint, etc., located on the lower portion of the head allows a user to tilt the head while the reservoir remains in a vertical position, thereby ensuring that the bottom of the supply tube maintains constant contact with the liquid in the reservoir.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a spray bottle having a self-adjusting handle of the present invention in which the adjusting means is a pivot point;

FIG. 2 is a rear view of a spray bottle having a self-adjusting handle of the present invention in which the adjusting means is a pivot point;

FIG. 3 is a side view of a spray bottle having a self-adjusting handle of the present invention in which the adjusting means is a ball joint;

FIG. 4 is a rear view of a spray bottle having a self-adjusting handle of the present invention in which the adjusting means is a ball joint;

FIG. 5 is a cross-section view along line 5-5 of FIG. 4 showing a ball joint of the present invention;

FIG. 6 is a side view of a spray bottle having a self-adjusting handle of the present invention in which the adjusting means is a universal joint;

FIG. 7 is a rear view of a spray bottle having a self-adjusting handle of the present invention in which the adjusting means is a universal joint; and

FIG. 8 is a cross-section view along line 8-8 of FIG. 7 showing a universal joint of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | spray bottle |
| 2. | self-adjusting handle |
| 3. | adjusting means |
| 4. | pivot point |
| 5. | head |
| 6. | cap |
| 7. | reservoir |
| 8. | trigger lever |
| 9. | pump |
| 10. | supply tube |
| 11. | barrel |
| 12. | nozzle |
| 13. | threaded portion of cap |
| 14. | tab |
| 15. | ball joint |
| 16. | ball |
| 17. | socket |
| 18. | partition |
| 19. | aperture |
| 20. | universal joint |
| 21. | spacer |

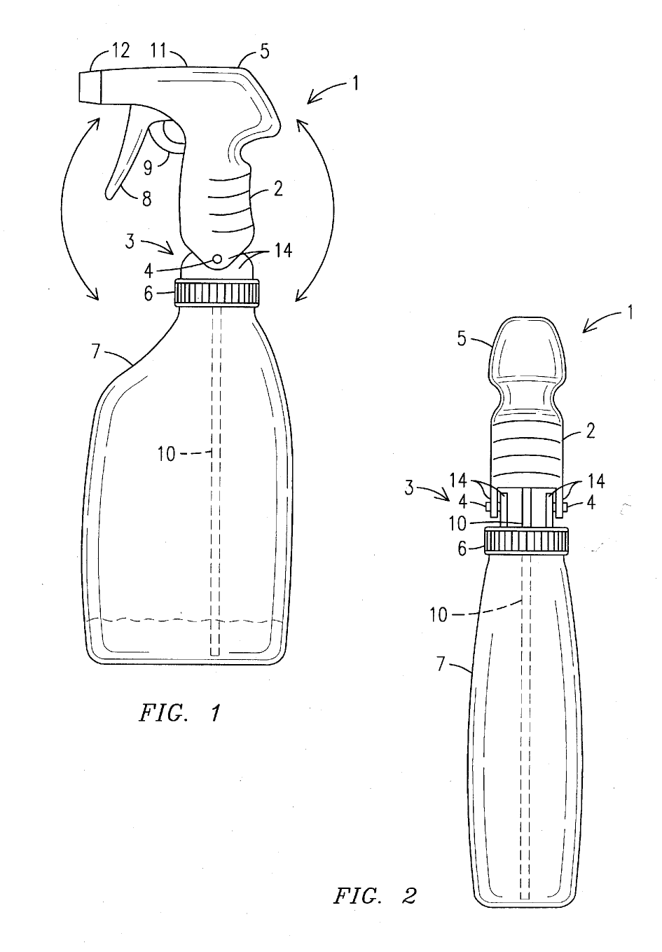

With reference to FIGS. 1 and 2, a front view and a rear view of a spray bottle 1 having a self-adjusting handle 2 of the present invention in which the adjusting means 3 is a pivot point 4, respectively, are shown. The spray bottle 1 comprises a head 5 extending from the handle 2 that is attached to a cap 6 via the adjusting means 3. The cap is attached to a reservoir 7 having a threaded portion that screws into a threaded portion 13 of the cap 6, as shown in FIG. 5. A trigger lever 8 located on the head 5 activates a pump 9. The pump 9 is attached to a supply tube 10 that draws fluid from the reservoir 7. The pump 9 forces this liquid up through the supply tube 10, through a barrel 11 and out a nozzle 12. The adjusting means 3 allows a user to pivot the head forward or backward while the reservoir 7 remains in an upright position. As shown here, the adjusting means 3 comprises pivot points 4 that attach the handle 2 having tabs 14 extending downward from the handle 2 to tabs 14 extending up from the cap 6. The pivot points 4 extent through the tabs 14 extending downward from the handle 2 and through the tabs 14 extending up from the cap 6.

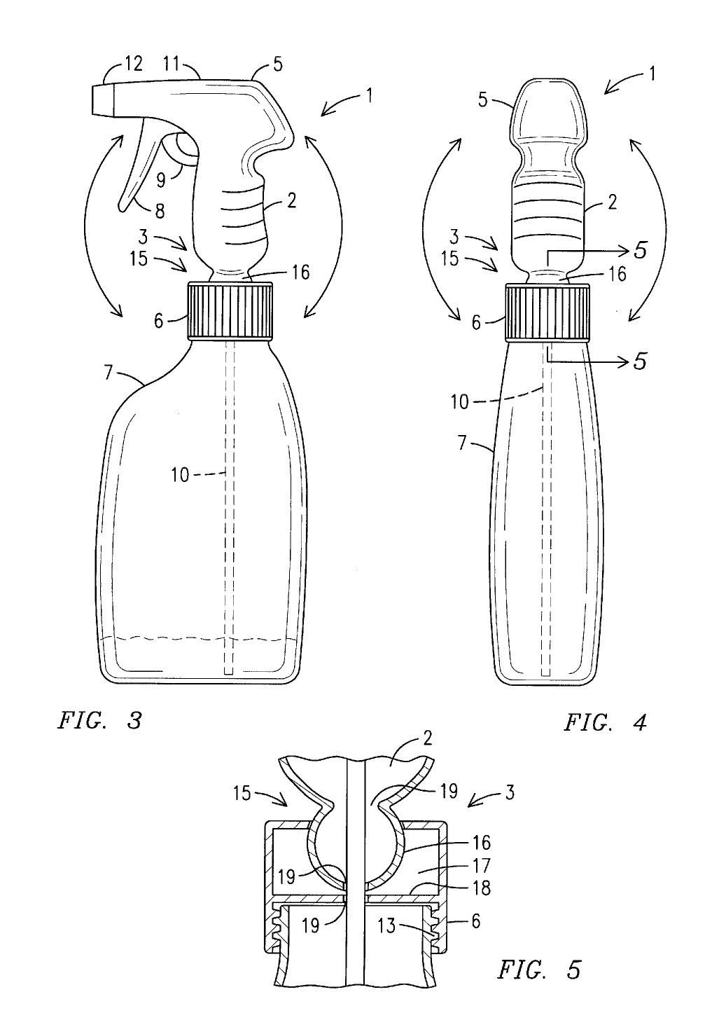

With reference to FIGS. 3, 4 and 5, a side view, a rear view and a cross-section view of a spray bottle 1 having a self-adjusting handle 2 of the present invention in which the adjusting means 3 is a ball joint 15, respectively, are shown. The spray bottle 1 comprises a head 5 extending from the handle 2 that is attached to a cap 6 via the adjusting means 3. The cap is attached to a reservoir 7 having a threaded portion that screws into a threaded portion 13 of the cap 6. A trigger lever 8 located on the head 5 activates a pump 9. The pump 9 is attached to a supply tube 10 that draws fluid from the reservoir 7. The pump 9 forces this liquid up through the supply tube 10, through a barrel 11 and out a nozzle 12. The adjusting means 3 allows a user to pivot the head forward, backward or side to side while the reservoir 7 remains in an upright position. As shown here, the adjusting means 3 is a ball joint 15 comprising a ball 16 extending downward from the handle 2 and located within a socket 17 extending upward from the cap 6. The socket 17 is separated from the threaded portion 13 of the cap 6 by a partition 18. The supply tube 10 passes through apertures 19 located in the partition 18 and in the ball 16.

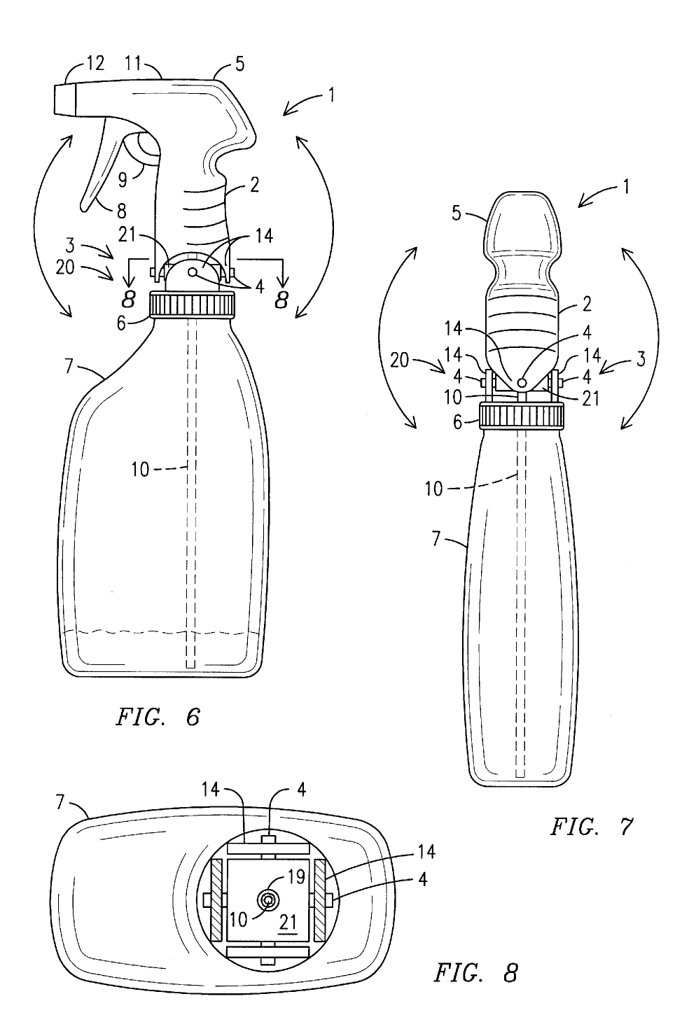

Finally with reference to FIGS. 6, 7 and 8, a side view, a rear view and a cross-section view of a spray bottle 1 having a self-adjusting handle 2 of the present invention in which the adjusting means 3 is a universal joint 20, respectively, are shown. The spray bottle 1 comprises a head 5 extending from the handle 2 that is attached to a cap 6 via the adjusting means 3. The cap is attached to a reservoir 7 having a threaded portion that screws into a threaded portion 13 of the cap 6, as shown in FIG. 5. A trigger lever 8 located on the head 5 activates a pump 9. The pump 9 is attached to a supply tube 10 that draws fluid from the reservoir 7. The pump 9 forces this liquid up through the supply tube 10, through a barrel 11 and out a nozzle 12. The adjusting means 3 allows a user to pivot the head forward, backward or side to side while the reservoir 7 remains in an upright position. As shown here, the adjusting means 3 is a universal joint 20 comprising tabs 14 extending downward from the handle 2 and tabs 14 extending upward from the cap 6. The tabs 14 are connected to a spacer 21 by pivot points 4. The supply tube 10 passes through an aperture 19 located in the spacer 21.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is considered not to be limited to what is shown and described in the specification and drawings.

Having thus described my invention, I claim:

1. A self-adjusting handle for spray bottles comprising:
a cap having a threaded portion located on an internal surface of the cap;
an aperture located in the cap;
a handle attached to the cap by an adjustment means;
a head extending upward from the handle;
a nozzle located on the head;
a trigger extending from the head for activating a pump attached to at least one supply tube; and
said at least one supply tube extending from the nozzle through the aperture located on the cap.

2. The self-adjusting handle for spray bottles of claim 1 wherein:
the adjustment means is at least one pivot point that attaches the cap to the handle.

3. The self-adjusting handle for spray bottles of claim 1 wherein:
the adjustment means is at least one pivot point that attaches the handle to at least one tab extending upward from the cap.

4. The self-adjusting handle for spray bottles of claim 1 wherein:
the adjustment means is at least one pivot point that attaches the cap to at least one tab extending downward from the handle.

5. The self-adjusting handle for spray bottles of claim 1 wherein:
the adjustment means is at least one tab extending downward for the handle that is attached to at least one tab extending upward from the cap by at least one pivot point.

6. The self-adjusting handle for spray bottles of claim 1 wherein:
the adjustment means is a ball joint.

7. The self-adjusting handle for spray bottles of claim 6 wherein:
the ball joint further comprises a ball extending downward from the handle;
said ball located within a socket extending upward from the cap; and
said socket is separated from the threaded portion of the cap by a partition.

8. The self-adjusting handle for spray bottles of claim 7 wherein:
said ball has an aperture that the supply tube passes through; and
said partition has an aperture that the supply tube passes through.

9. The self-adjusting handle for spray bottles of claim 1 wherein:
the adjustment means is a universal joint.

10. The self-adjusting handle for spray bottles of claim 9 wherein:
the universal joint further comprises at least two tabs extending downward from the handle that are pivotally attached to a spacer; and
at least two tabs extending upward from the handle that are pivotally attached to the spacer.

11. The self-adjusting handle for spray bottles of claim 10 wherein:
said spacer has an aperture that the supply tube passes through.

12. A self-adjusting handle for spray bottles comprising:
a cap having a threaded portion located on an internal surface of the cap;
an aperture located in the cap;
a handle attached to the cap by at least one pivot point;
a head extending upward from the handle;
a nozzle located on the head;
a trigger extending from the head for activating a pump attached to at least one supply tube; and
said at least one supply tube extending from the nozzle through the aperture located on the cap.

13. The self-adjusting handle for spray bottles of claim 12 wherein:
the handle is attached to the cap by at least one pivot point that attaches the handle to at least one tab extending upward from the cap.

14. The self-adjusting handle for spray bottles of claim 12 wherein:
the handle is attached to the cap by at least one pivot point that attaches the cap to at least one tab extending downward from the handle.

15. The self-adjusting handle for spray bottles of claim 12 wherein:
the handle is attached to the cap by at least one tab extending downward for the handle that is attached to at least one tab extending upward from the cap by at least one pivot point.

16. The self-adjusting handle for spray bottles of claim 12 wherein:
the handle is attached to the cap by at least two tabs extending downward from the handle that are pivotally attached to a spacer; and
at least two tabs extending upward from the handle that are pivotally attached to the spacer.

17. The self-adjusting handle for spray bottles of claim 16 wherein:
said spacer has an aperture that the supply tube passes through; and

18. A self-adjusting handle for spray bottles comprising:
a cap having a threaded portion located on an internal surface of the cap;
an aperture located in the cap;
a handle attached to the cap by a ball joint;
a head extending upward from the handle;
a nozzle located on the head;
a trigger extending from the head for activating a pump attached to at least one supply tube; and
said at least one supply tube extending from the nozzle through the aperture located on the cap.

19. The self-adjusting handle for spray bottles of claim 18 wherein:
the ball joint further comprises a ball extending downward from the handle;
said ball located within a socket extending upward from the cap; and
said socket is separated from the threaded portion of the cap by a partition.

20. The self-adjusting handle for spray bottles of claim 18 wherein:
said ball has an aperture that the supply tube passes through; and
said partition has an aperture that the supply tube passes through.
